(19) United States
(12) Patent Application Publication
(10) Pub. No.: US 2007/0299605 A1
(43) Pub. Date: Dec. 27, 2007

(54) Map Providing Device, Mobile Terminal, Map Providing Method, Map Display Method, Map Providing Program, And Map Display Program

(75) Inventors: Keisuke Onishi, Tokyo (JP); Shin Kikuchi, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Navitime Japan Co., Ltd., Tokyo (JP)

(21) Appl. No.: 10/569,075

(22) PCT Filed: Aug. 10, 2004
(86) PCT No.: PCT/JP04/11468

§ 371 Date: Dec. 1, 2006

(30) Foreign Application Priority Data
Aug. 21, 2003 (JP) 2003-297541

(51) Int. Cl. G01C 21/32

(52) U.S. Cl. 701/208; 701/209; 340/995.1

(57) ABSTRACT

The present invention provides a map providing apparatus (10) that receives, from a portable terminal (30) including at least a display unit (32), a piece of position information that indicates a location point of the portable terminal (30) and transmits, to the portable terminal (30), a map image that corresponds to the received piece of position information. The map providing apparatus (10) includes: a reference direction specifying unit (104) that specifies a reference direction that is required when a user of the portable terminal (30) brings the map image displayed on the display unit (32) of the portable terminal (30) into correspondence with actual directions, based on the piece of position information received from the portable terminal (30); a reference direction information generating unit (100) that generates a piece of reference direction information for having the user of the portable terminal (30) understand the reference direction specified by the reference direction specifying unit (104); and a transmitting unit (100) that transmits, to the portable terminal, the piece of reference direction information generated by the reference direction information generating unit (100), together with the map image.

### TECHNICAL FIELD

The present invention relates to a map providing apparatus, a map providing method, and a map providing program for transmitting a map image to be displayed on a display unit of a portable terminal to the portable terminal, and relates to a portable terminal, a map displaying method, and a map displaying program for displaying a map image.

### BACKGROUND ART

Conventionally, services for distributing map images via a network are publicly known. In addition, various techniques have been proposed for improving the convenience of users. For example, there is known a technique for rotating a map image to be distributed so that a predetermined direction in the map image is arranged to be in an up-and-down direction of the display unit of a distribution target apparatus. With this technique, for example, when a map image that includes a route to a destination is distributed, it is possible to display the map image on a display unit of an apparatus in such a manner that the direction of the destination is always positioned at the upper side of the display unit. (For example, see Patent Document 1.)

Patent Document 1: The Japanese Unexamined Patent Application Publication No. 2001-111893

### DISCLOSURE OF INVENTION

Problem to be Solved by the Invention

As described above, various techniques have been developed to improve the convenience of users; however, a user may find it difficult to understand the directions, especially in a place to which he/she has never been before. On such occasions, even if the user is provided with a map, he/she will find it difficult to understand a relationship between the actual directions and the traveling direction on the displayed map.

In order to solve this problem, one approach is to use a compass; however, it is inconvenient to carry a compass around. Another possible method would be to incorporate a compass into an apparatus, such as a portable terminal, on which map images are to be displayed; however, this method brings up other problems such as making the scale of the apparatus larger and spending development costs. Thus, some other solutions are needed.

In view of the problems stated above, the present invention aims to provide a map providing apparatus that provides a map with which a user is able to easily understand a relationship between actual directions and directions on the map, without having to use a means for specifying directions such as a compass.

Means for Solving Problem

To solve the above problems and to achieve the above object, according to an aspect of the present invention, a map providing apparatus that receives, from a portable terminal including at least a display unit, a piece of position information indicating a location point of the portable terminal and transmits, to the portable terminal, a map image that corresponds to the received piece of position information, the map providing apparatus includes a reference direction specifying unit that specifies a reference direction that is required when a user of the portable terminal brings the map image displayed on the display unit of the portable terminal into correspondence with actual directions, based on the piece of position information received from the portable terminal; a reference direction information generating unit that generates a piece of reference direction information for having the user of the portable terminal understand the reference direction specified by the reference direction specifying unit; and a transmitting unit that transmits the piece of reference direction information generated by the reference direction information generating unit to the portable terminal, together with the map image.

The reference direction here denotes a piece of information that indicates which direction in the map image corresponds to north. The corresponding direction does not have to be north. It is acceptable as long as it is possible to specify some direction in the map image.

According to the present invention, the map providing apparatus transmits, to a portable terminal and together with a map image, a piece of reference direction information that enables a user to understand a reference direction that is required when the directions in the map image are brought into correspondence with the actual directions. With this arrangement, an effect is achieved where the user of the portable terminal is able to easily understand the relationship between the directions on the map and the actual directions, based on the piece of reference direction information.

Further, according to the present invention, it is possible to specify the direction of a target object with respect to a map image, for example, when an arrangement is made in advance so that the map image is displayed in such a manner that north in the map image is always positioned at the upper side of the display unit.

### EFFECT OF THE INVENTION

According to the present invention, the map providing apparatus transmits, to a portable terminal and together with a map image, a piece of reference direction information that enables a user to understand a reference direction that is required when the directions in the map image are brought into correspondence with the actual directions. With this arrangement, an effect is achieved where the user of the portable terminal is able to easily understand the relationship between the directions on the map and the actual directions, based on the piece of reference direction information.

### BRIEF DESCRIPTION OF DRAWINGS

FIG. 1 is a schematic of an overall configuration of a map providing system 1;

FIG. 2 is a schematic diagram for explaining contents of a landmark table 120;

FIG. 3 is a flow chart of a map providing processing;

FIG. 4 is a flow chart of the details of a target object selecting processing (step S120) shown in FIG. 3;

FIG. 5 is a drawing of a display unit 32 on which a shadow image is displayed;

FIG. 6 is a drawing for explaining how to bring a map image displayed on the display unit 32 into correspondence with the actual directions;

FIG. 7 is a drawing of the display unit 32 on which a landmark is displayed;

FIG. 8 is a drawing of the display unit 32 on which the moon is displayed;

FIG. 9 is a diagram of the hardware configuration of a map providing apparatus 10;

FIG. 10 is a block diagram of the functional configuration of the map providing apparatus 10 according to a second embodiment;

FIG. 11 is a diagram of the data configuration of a shadow direction table 130;

FIG. 12 is a flow chart of a map providing processing according to a third embodiment; and

FIG. 13 is a drawing for explaining how to select a landmark.

### EXPLANATIONS OF LETTERS OR NUMERALS

1: map providing system
2: network
10: map providing apparatus
20: map database
30: mobile phone
32: display unit
100: communicating unit
102: target object selecting unit
104: reference direction specifying unit
106: map image editing unit
108: map direction specifying unit
110: map image extracting unit
120: landmark table
130: shadow direction table

### BEST MODE(S) FOR CARRYING OUT THE INVENTION

Exemplary embodiments of a map providing apparatus, a portable terminal, a map providing method, a map displaying method, a map providing program, and a map displaying program according to the present invention are explained in detailed below with reference to the accompanying drawings. The present invention, however, is not limited to these embodiments.

### FIRST EMBODIMENT

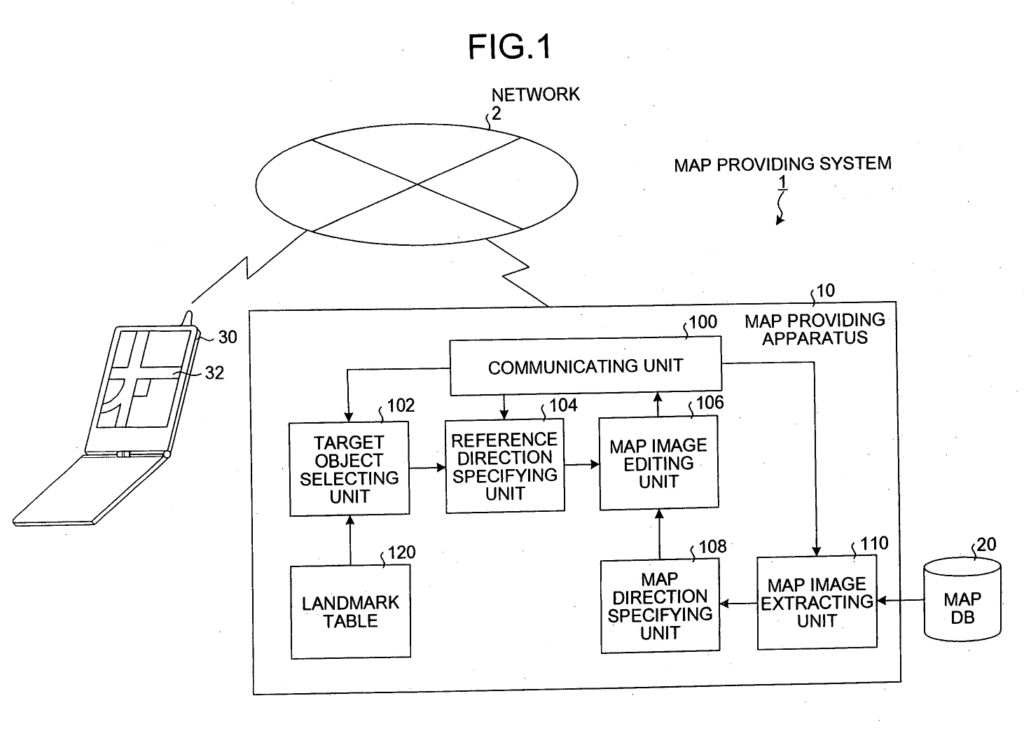

FIG. 1 is a diagram of the overall configuration of a map providing system 1 that includes a map providing apparatus 10 according to an embodiment of the present invention. The map providing system 1 includes the map providing apparatus 10 and a mobile phone 30. The map providing apparatus 10 distributes a map image to be displayed on a display unit 32 of the mobile phone 30 via a network 2.

The map providing apparatus 10 transmits a piece of information indicative of a relationship between directions on the map displayed on the display unit 32 and actual directions at the location of the mobile phone 30. In the present embodiment, the transmitted information is a piece of reference direction information that indicates the relationship between the directions on the map and the actual directions. The piece of reference direction information here denotes a piece of information that indicates the direction of a target object that the user is actually able to visually recognize. To be more specific, the user is able to understand the relationship between the directions on the map and the actual directions, based on the direction of the target object that he/she is actually able to visually recognize and the piece of reference direction information displayed on the mobile phone 30.

The target object an object that the user of the mobile phone 30 can visually recognize from the location point of the mobile phone 30. More specifically, the target object may be an astronomical object such as the sun, the moon, or a constellation, a shadow of the user or the like formed by the sunlight, or a landmark such as a high-rise building. In the present embodiment, a shadow, the moon, and a landmark are used as target objects.

Next, the processing performed by the map providing apparatus 10 for providing information that indicates directions will be explained. The map providing apparatus 10 includes a communicating unit 100, a target object selecting unit 102, a reference direction specifying unit 104, a map image editing unit 106, a map direction specifying unit 108, a map image extracting unit 110, and a landmark table 120. The map providing apparatus 10 further includes a map data base 20.

The communicating unit 100 transmits and receives data to and from the mobile phone 30 via the network 2. The landmark table 120 shows, in correspondence, location points of the mobile phone 30 and landmarks to be transmitted to the mobile phone 30 together with a map image of each of the location points. The landmark table 120 will be explained in detail later.

The target object selecting unit 102 obtains a piece of weather information that indicates the weather at the date and time of the transmission of the map image, from the outside of the map providing apparatus 10 via the communicating unit 100. The target object selecting unit 102 selects a target object to be transmitted to the mobile phone 30, based on the obtained piece of weather information and a piece of date and time information that indicates the date and time of the transmission of the map image.

The piece of weather information according to the present embodiment is information that indicates a current weather, i.e. the weather at a time when the target object selecting unit 102 is performing the processing. Because the date and time at which the map image is to be transmitted is substantially the same as the date and time at which the target object selecting unit 102 performs the processing, the piece of weather information at the time of the processing is used according to the present embodiment. Likewise, a piece of information that indicates a current date and time, in other words, a piece of information that indicates a date and time at which the target object selecting unit 102 is performing the processing is used as the piece of date and time information according to the present embodiment.

When having selected a landmark as a target object, the target object selecting unit 102 selects one or more appropriate landmarks out of the plurality of landmarks included in the landmark table 120. The target object selecting unit 102 may select one landmark or more than one landmark. The target object selecting unit 102 according to the present embodiment includes a landmark selecting unit according to the present invention.

The reference direction specifying unit 104 obtains a piece of position information that indicates a location point of the mobile phone 30, via the communicating unit 100. The reference direction specifying unit 104 specifies a reference direction based on the obtained piece of position information. The reference direction here denotes a direction that is required when a user is to bring the directions in a map image displayed on the display unit 32 of the mobile phone 30 into correspondence with the actual directions. To be more specific, the reference direction is the direction of a target object with respect to the location point of the mobile phone 30. For example, it is the direction of a landmark with respect to the location point of a user of the mobile phone 30. The direction of the landmark may be expressed as a direction, for example, north-northwest.

The map data base 20 stores therein map images to be provided for the mobile phone 30. All of the map images stored in the network 20 according to the present embodiment are oriented so that the direction of north in each map image is in correspondence with the upper side of the display unit when being displayed in the display unit.

The map image extracting unit 110 obtains a map request from the mobile phone 30 via the communicating unit 100. The map request indicates that a map showing a route to a destination desired by a user is requested. The map image extracting unit 110 then extracts a map image of the area indicated by the map request, from the network 20. The map image extracting unit 110 further rotates the extracted map image so that the upper side of the display unit 32 of the mobile phone 30 is in correspondence with the direction of the destination. With this arrangement, it is possible to have a map image displayed on the display unit 32 of the mobile phone 30 in such a manner that the direction of a destination is always positioned at the upper side of the display unit 32.

The map direction specifying unit 108 specifies a map direction, which is a direction on the map provided for the mobile phone 30. As explained above, the map image extracted by the map image extracting unit 110 has been rotated in accordance with the destination. Thus, the relationship between the direction of north in the map image and the upper side of the map image will vary for each of map images. The map direction specifying unit 108 therefore specifies the direction of north for each map image. The direction specified by the map direction specifying unit 108 may be any predetermined direction and does not have to be limited to north.

The map image editing unit 106 embeds an image of the target object into the map image extracted by the map image extracting unit 110, based on the reference direction specified by the reference direction specifying unit 104 and the map direction specified by the map direction specifying unit 108. The image of the target object according to the present embodiment corresponds to the reference direction information according to the present invention. The map image editing unit 106 according to the present embodiment is included in the reference direction information generating unit according to the present invention.

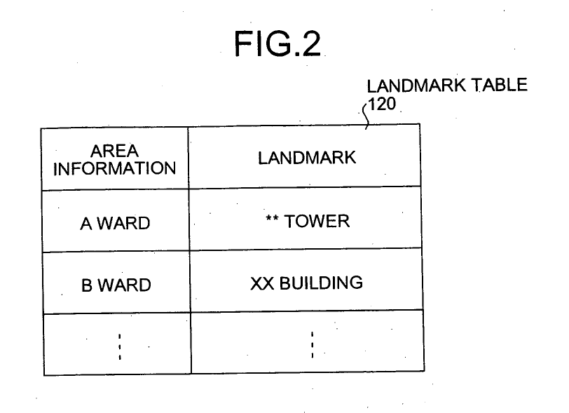

FIG. 2 schematically shows the data configuration of the landmark table 120 described with reference to FIG. 1. The landmark table 120 shows, in correspondence, pieces of area information and landmarks. Each of the pieces of area information indicates, for example, an area having a predetermined size, like A Ward or B Ward. Each of the landmarks is a building that can be visually recognized by a user from a corresponding area, like “** Tower”. According to this arrangement, when the location point of the portable terminal 30 is in A Ward, for example, the target object selecting unit 102 selects “** Tower” as an appropriate landmark. In other words, the map providing apparatus 10 provides a piece of reference direction information that uses “** Tower” as the target object for the portable terminal 30.

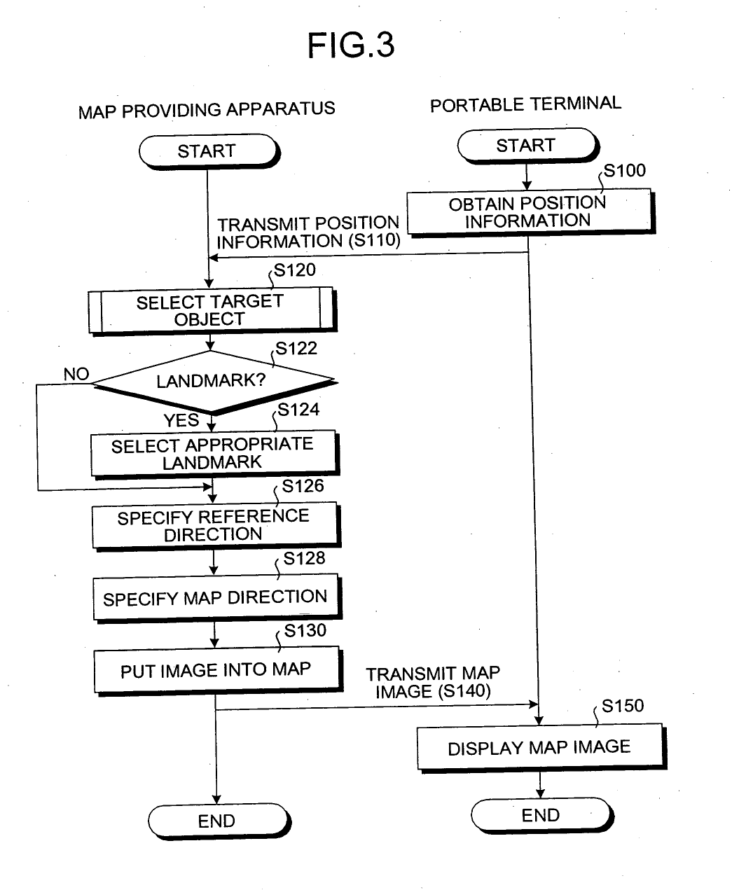

FIG. 3 is a flow chart of a map providing processing. As a premise, the mobile phone 30 has requested the map providing apparatus 10 that a route to a desired destination should be searched for. The map providing apparatus 10, in turn, transmits a map image that includes the route to the destination that has been specified as a result of the search, to the mobile phone 30.

In this situation, firstly, the mobile phone 30 obtains a piece of position information that indicates the location point of the mobile phone 30 (step S100). For example, the piece of position information may be obtained using a Global Positioning System (GPS). Next, the mobile phone 30 transmits the obtained piece of position information to the map providing apparatus 10 (step S110).

Having received the piece of position information from the mobile phone 30, the communicating unit 100 of the map providing apparatus 10 forwards the piece of position information to the target object selecting unit 102. The target object selecting unit 102 then selects a target object to be put into the map image (step S120). At this time, the target object selecting unit 102 selects one of a shadow, a landmark, and the moon, as the target object. The method of how to select the target object will be described later.

When a landmark is selected as the target object (step S122: Yes), an area in which the location point of the mobile phone 30 exists is specified, based on the piece of position information. Further, a landmark is selected that is in correspondence with the area in which the mobile phone 30 is located, using the landmark table 120 (step S124).

Subsequently, the reference direction specifying unit 104 specifies the direction of the selected target object, i.e. the reference direction (step S126). When a landmark is used as the target object, the reference direction specifying unit 104 specifies the direction of the landmark with respect to the map image, based on the position of the mobile phone 30 and the position of the landmark.

Alternatively, when a shadow is used as the target object, the direction of a shadow with respect to the map image is specified as the reference direction, based on the piece of position information that indicates the location point of the mobile phone 30 and a piece of date and time information. More specifically, for the sake of convenience, it is presumed that the direction of a shadow at 6:00 a. m. is west, the direction of a shadow at 12:00 noon is north, and the direction of the shadow at 6:00 p. m. is east. Further, it is also presumed that the direction of a shadow moves 15 degrees per hour. Under these presumptions, the directions of a shadow at different times on different dates are calculated. From this calculation, for example when the current time is 9:00 a. m., the direction of a shadow is specified as the northwest direction on the map.

When the moon is used as the target object, the method of how to specify the direction of the moon is similar to the method of how to specify the direction of a shadow.

When the reference direction has been specified through the processing described above, the map direction specifying unit 108 then specifies a map direction (step S128). More specifically, the map direction specifying unit 108 specifies the map direction based on a rotation angle by which the map image extracting unit 110 has rotated the map image extracted from the network 20. Next, the map image editing unit 106 puts the target object into the map image, based on the map direction specified by the map direction specifying unit 108 and the reference direction specified by the reference direction specifying unit 104 (step S130). Subsequently, the communicating unit 100 transmits the map image into which the map image editing unit 106 has put the target object, to the mobile phone 30 (step S140). The mobile phone 30 displays the received map image on the display unit 32 (step S150). Thus, the map providing processing is completed.

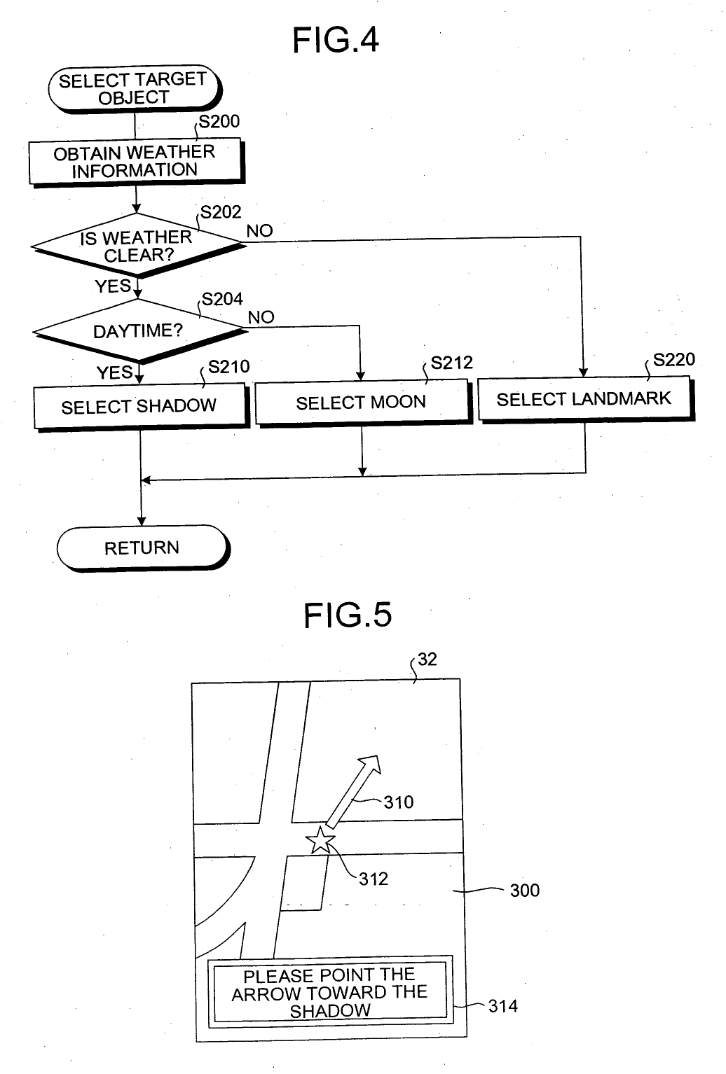

FIG. 4 is a flow chart of the details of the processing performed by the map providing apparatus 10 during the target object selecting processing (step S120). Firstly, in the target object selecting processing, the target object selecting unit 102 further obtains a piece of weather information from the network 2 via the communicating unit 100 (step S200). The target object selecting unit 102 then selects a target object that is to be put into a map image, based on the piece of weather information and the piece of date and time information.

When the current weather is clear and the current time is daytime (step S202: Yes; Step S204: Yes), the target object selecting unit 102 selects a shadow as the target object (step S210). In this situation, “daytime” denotes any time between 6:00 a. m. and 6:00 p. m. Any time between 6:00 p. m. and 6:00 a. m. is defined as “nighttime”. It is, however, optional at what time the selection between a shadow and the moon is changed. The time at which the selection is changed may be altered depending on the seasons.

Alternatively, when the current weather is clear and the current time is nighttime (step S202: Yes; step S204: No), the target object selecting unit 102 selects the moon as the target object (step S212).

As described so far, the target object selecting unit 102 selects a shadow as the target object during the daytime when a shadow is visible and selects the moon or a constellation as the target object during the nighttime when no shadow is visible. With this arrangement, because an appropriate target object is selected depending on whether the current time is daytime or nighttime, it is possible to put a target object that is easy to be visually recognized by the user into the map image at all times.

Alternatively, when the current weather is cloudy (step S202: No), the target object selecting unit 102 selects a landmark as the target object (step S220). When the weather is cloudy, or the like, it is difficult for the user to visually recognize a shadow. Thus, on such an occasion, a landmark, instead of a shadow, is used as the target object. With this arrangement, because an appropriate target object is selected depending on the current weather, it is possible to put a target object that is easy to be visually recognized by the user at all times. Thus, the processing related to the landmark table 120 is completed. The procedures then advances to step S122, which is shown in FIG. 3.

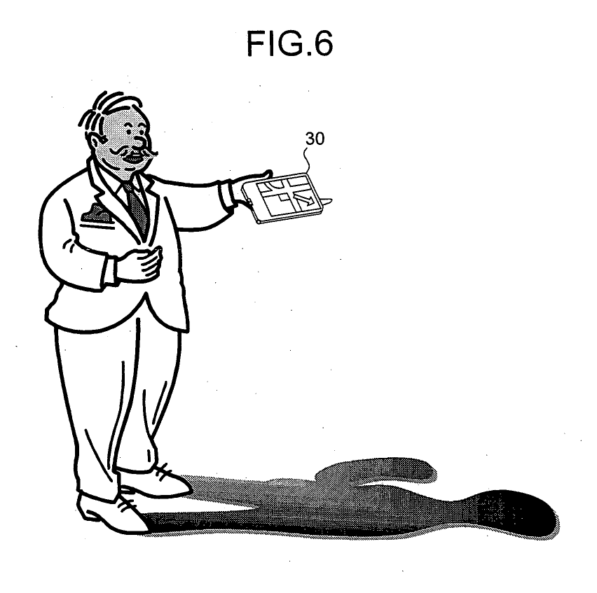

FIG. 5 is a drawing of a map image being displayed on the display unit 32. FIG. 6 is a drawing for explaining the processing to bring the upper side of the display unit 32 into correspondence with the traveling direction. A star symbol 312 that indicates the current position and a shadow image 310 are embedded in a map image 300 shown in FIG. 5. In this way, the map image and the image of the target object are displayed at the same time. It should be noted that, when a shadow is selected during the target object selecting processing (step S120) explained using FIG. 3, the shadow image 310, such as the one shown in FIG. 5, is to be displayed.

The map image 300 is displayed in such a manner that the direction of the destination is in correspondence with the upper side of the display unit 32. When the user brings the upper side of the display unit 32 into correspondence with the actual direction of the destination, the shadow image 310 is pointing to a direction towards which the actual shadow extends. In other words, the user is able to specify his/her traveling direction based on the shadow direction indicated by the shadow image 310 and the actual direction towards which his/her own shadow formed by the sunlight extends.

As shown in FIG. 6, the user holds the mobile phone 30 so that the upper side of the mobile phone 30 is positioned to his/her fore. While holding the mobile phone 30 in such a manner, the user changes the orientation of his/her body so that the shadow direction indicated by the shadow image 310 is brought into correspondence with the actual direction of the shadow. When the indicated shadow direction is in correspondence with the actual shadow direction, the direction at which the upper side of the mobile phone 30 is positioned is the traveling direction. In other words, by bringing the shadow image 310 into correspondence with the actual shadow direction, it is possible to bring the directions on the map into correspondence with the actual directions.

People sometimes have experience that, even if a map resulting from a search is displayed, they cannot understand the relationship between the directions on the map and the actual directions, especially when they are at places with which they are not very familiar. However, the map providing apparatus 10 according to the present embodiment provides the map image 300 in which the shadow image 310 to be used for identifying directions is embedded. It is therefore possible for the user to easily understand the relationship between the directions on the map and the actual directions, based on the shadow image 310 and by following an instruction displayed in an instruction box 314.

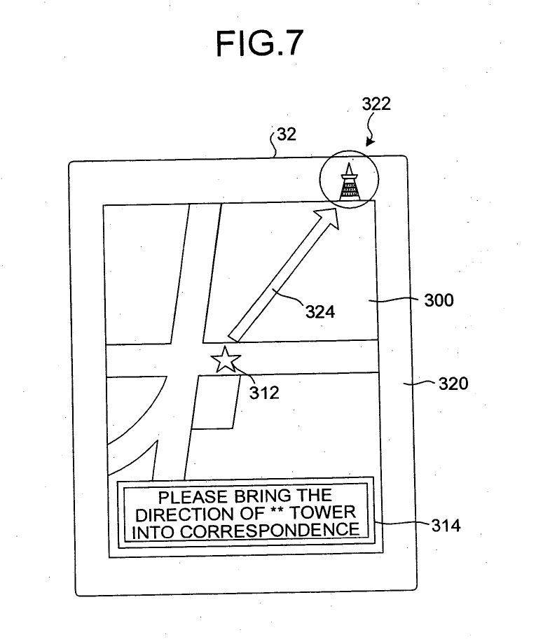

FIG. 7 is a drawing of a landmark image 322 being displayed on the display unit 32. When a landmark is selected during the target object selecting processing (step S120) explained using FIG. 3, the landmark image 3w2 is to be displayed. At this time also, the map image 300 is displayed in such a manner that the direction of the destination is in correspondence with the upper side of the display unit 32, like the map image 300 explained using FIG. 5. A target object display area 320 is provided around the map image 300. The landmark image 312 is arranged to be at such a position that the direction of the landmark image 322 with respect to the center of the display unit 32 is in correspondence with the direction of the actual landmark with respect to the center of the display unit 32.

As shown in FIG. 7, when the landmark image 322 is displayed on the upper right section of the map image 300, the user holds the mobile phone 30 so that the upper side of the mobile phone 30 is positioned to his/her fore. The user then changes the orientation of his/her body so that he/she sees the landmark to his/her right fore. The user is able to bring the directions on the map into correspondence with the actual directions by bringing an arrow 324 indicating the direction of the landmark image 312 with respect to the current position indicated by the star symbol 312 on the display unit 32 into correspondence with the direction of the landmark with respect to the actual current position. Thus, also when the landmark image 322 is used, it is possible for the user to easily understand the directions on the map, like when the shadow image 310 is used.

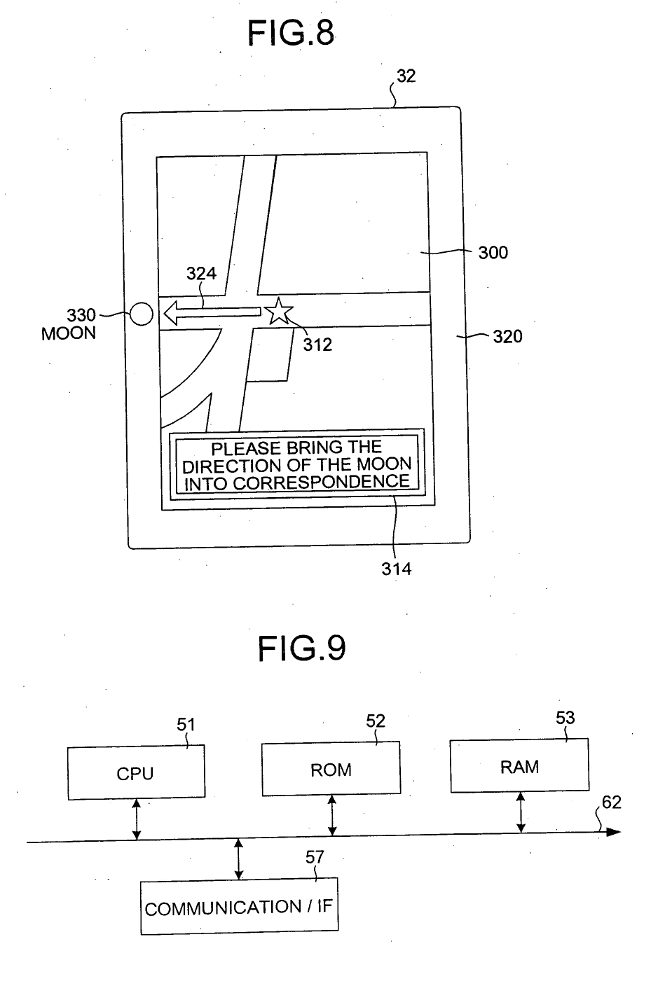

FIG. 8 is a drawing of a moon image 330 being displayed on the display unit 32. When the moon is selected during the target object selecting processing (step S120) explained using FIG. 3, the moon image 330 is to be displayed. At this time also, like the displayed image explained using FIG. 7, the instruction box 314 is provided. Within the instruction box 314, the moon image 330 is displayed at a position that is in correspondence with the reference direction with respect to the map image 300. In this case also, the user holds the mobile phone 30 so that the upper side of the mobile phone 30 is positioned to his/her fore. The user then changes the orientation of his/her body so that he/she sees the moon to his/her left. This way, the user is able to understand the directions in the map image. As explained so far, it is possible for the user to easily understand the directions on the map, also when the moon image 330 is used, like when the shadow image 310 is used and when the landmark image 322 is used.

FIG. 9 is a diagram of the hard ware configuration of the map providing apparatus 10. The map providing apparatus 10 includes, as its hardware configuration, a ROM 52 that stores therein, for example, a program for executing the map providing processing performed by the map providing apparatus 10, a CPU 51 that controls the constituent elements of the map providing apparatus 10 in accordance with the program stored in the ROM 52 and executes, for example, the map providing processing, a RAM 53 in which a work area is formed and that stores therein various types of data that are necessary for controlling the map providing apparatus 10, a communication I/F 57 that is connected to a network and performs communication, and a bus 62 that connects these constituent elements to one another.

The map providing program that executes the document management processing processing that is performed by the map providing apparatus 10 and has been explained above is provided as being recorded on a computer-readable recording medium such as a CD-ROM, a floppy (registered trademark) disk (FD), a DVD, or the like, in an installable format or in an executable format.

It is also acceptable to have an arrangement wherein the map providing program according to the present embodiment is stored in a computer connected to a network such as the Internet and is provided as being downloaded via the network.

With this arrangement, the map providing program is loaded onto a main memory device when being read from the recording medium and executed in the map providing apparatus 10, and the constituent elements explained as the software configuration are generated on the main storage device.

### SECOND EMBODIMENT

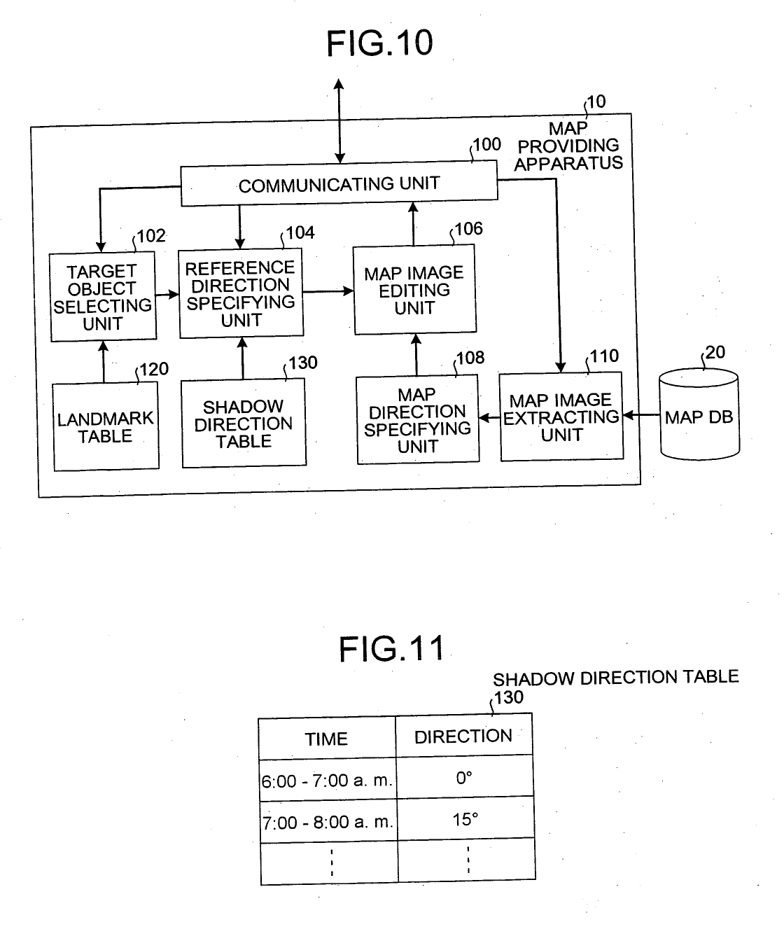

FIG. 10 is a block diagram of the functional configuration of the map providing apparatus 10 according to a second embodiment. The map providing apparatus 10 according to the second embodiment further includes a shadow direction table 130, in addition to the configuration of the map providing apparatus 10 according to the first embodiment. The reference direction specifying unit 104 according to the second embodiment specifies a shadow direction using the shadow direction table 130, whereas the reference direction specifying unit 104 according to the first embodiment specifies the shadow direction by calculation. In terms of this technical feature, the map providing apparatus 10 according to the second embodiment is different from the map providing apparatus 10 according to the first embodiment.

FIG. 11 is a diagram of the data configuration of the shadow direction table 130. The shadow direction table 130 shows times and directions in correspondence. Accordingly, the reference direction specifying unit 104 is able to specify, as the shadow direction, a direction that is in correspondence with a current time by referring to the shadow direction table 130.

Other configurations and other steps in the processing of the map providing system 1 including the map providing apparatus 10 besides the arrangement described here are the same as the configurations and the steps in the processing of the map providing system 1 according to the first embodiment.

### THIRD EMBODIMENT

In the map providing system 1 according to a third embodiment, the mobile phone 30 specifies the direction of a target object. In terms of this technical feature, the map providing system 1 according to the third embodiment is different from the map providing system 1 according to the first embodiment and the second embodiment.

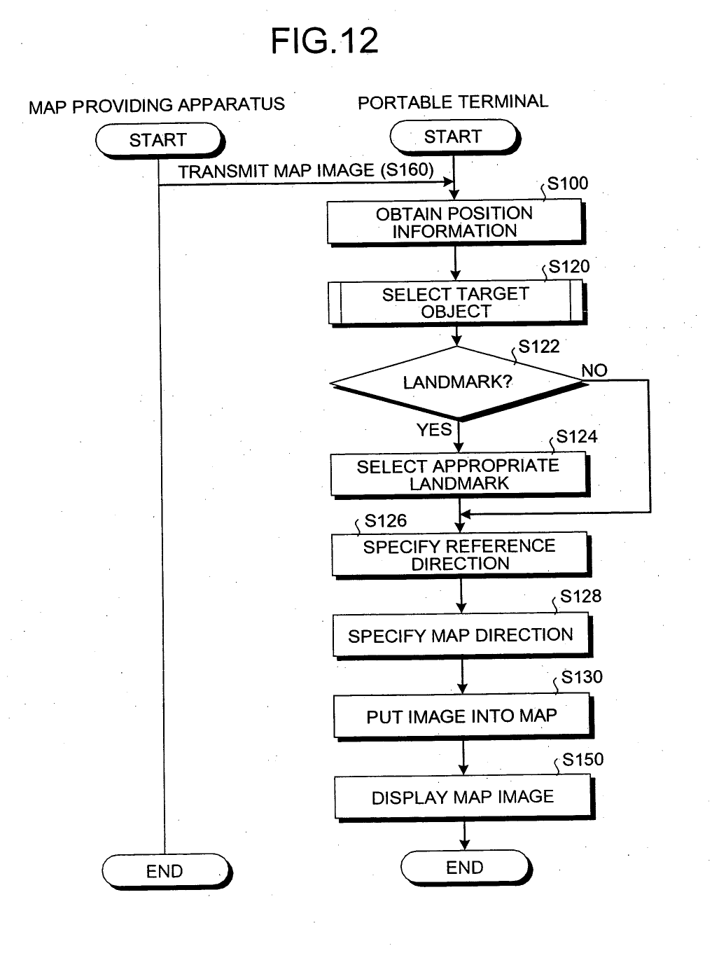

The mobile phone 30 according to the third embodiment includes the constituent elements of the map providing apparatus 10 explained with reference to FIG. 1 in the description of the first embodiment. FIG. 12 is a flow chart of a map providing processing according to the third embodiment. According to the third embodiment, firstly, the map providing apparatus 10 supplies a map image that includes a route to a destination, to the mobile phone 30 (step S160). Having received the map image, the mobile phone 30 further obtains a piece of position information (step S100). After that, the procedure from the processing for specifying a target object through the processing for putting an image of the target object into the map image (i.e. step S100 through step S130) is the same as the steps in the processing explained in the description of the first embodiment. It should be noted that, according to the third embodiment, the communicating unit 100 of the mobile phone 30 receives, from the map providing apparatus 10, a piece of map direction information indicating a direction that is in correspondence with the upper side of the map image, together with the map image. The map direction specifying unit 108 included in the mobile phone 30 specifies the map direction based on the piece of map direction information. In terms of this technical feature, the processing is different from the processing according to the first embodiment.

Other configurations and other steps in the processing of the map providing system 1 besides the arrangement described here are the same as the configurations and the steps in the processing of the map providing system 1 according to the first embodiment and the second embodiment.

So far, the present invention has been described using the examples of the embodiments; however, it is to modify and/or change the embodiments described above in various ways.

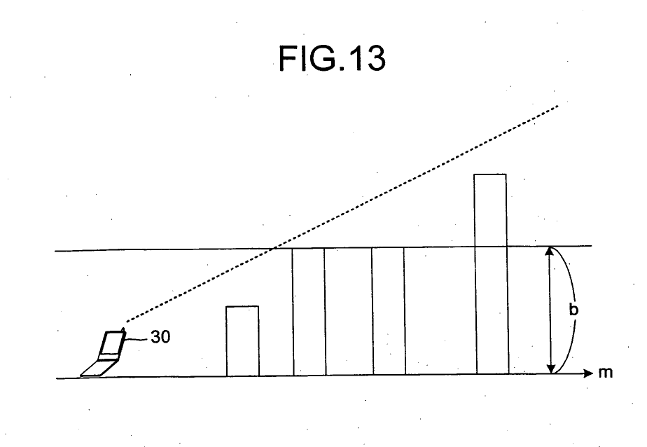

For example, according to the embodiments, the target object selecting unit 102 selects an appropriate landmark out of the plurality of landmarks using the landmark table 120. However, the target object selecting unit 102 can be configured so at to select a landmark through the following processing. FIG. 13 is a drawing for explaining how to select a landmark. For example, a reference height b is set in advance for buildings and mountains that are to be used as landmarks. Out of the landmarks that are positioned on a straight line m that extends from the position of the mobile phone 30 toward a predetermined direction, a landmark that is the closest to the mobile phone 30 is determined as the landmark to be put into the map image.

It is also acceptable to have an arrangement wherein a landmark that can be easily specified by a user even though it is located in a long distance, for example, Mount Fuji, may be selected with a higher priority, instead of using the method described above. Further, it is acceptable to have an arrangement wherein, if there is a building or the like that is located closer to the mobile phone 30 than Mount Fuji is and that has a height that forms, in relation to the mobile phone 30, an elevation angle larger than an elevation angle formed by the top of Mount Fuji, such a building is selected as the landmark. With this arrangement, when a user is not able to visually recognize Mount Fuji because of a building located closer to the user than Mount Fuji is, it is possible to select the building other than Mount Fuji as the landmark.

Moreover, according to the embodiments, a shadow is specified as the target object during the daytime hours. However, it is acceptable to select the sun as the target object, instead. When the weather is sunny, the sunlight may be too bright for a user to visually recognize the position of the sun. In such a situation, it may be easier to visually recognize a shadow than the sun. On the other hand, when the weather is cloudy, it may be difficult to specify a shadow because the shadow is light-colored, and it may be easy to visually recognize the sun because the sun is hidden by the clouds. In such a situation, it is easier to visually recognize the sun than a shadow. Accordingly, also when the sun is used as the target object, the user is able to understand the relationship between the directions in a map and the actual directions, just like when a shadow is used as the target object.

The processing for specifying the direction of the sun mentioned here is the same as the processing for specifying the direction of a shadow. It should be noted that when the direction of the sun is used, the directions to be used as references are east at 6:00 a. m., south at 12:00 noon, and west at 6:00 p.m.

Furthermore, according to the embodiments, the moon is specified as the target object during the nighttime hours. However, it is acceptable to select a constellation as the target object, instead. It is also acceptable to change the constellation to be selected as the target object, depending on the seasons. With this arrangement, it is possible to specify the direction based on the constellation that is easy to visually recognize for each season. The processing for specifying the direction of the constellation mentioned here is the same as the processing for specifying the direction of a shadow.

Moreover, according to the embodiments, the map providing apparatus 10 provides, to the mobile phone 30, the target object image for having the target object displayed on the display unit 32, by putting the target object image into the map image. As for a fourth modification example, it is acceptable to have an arrangement wherein a piece of text information that indicates a target object is transmitted to the mobile phone 30, together with a map image. More specifically, the piece of text information may read, for example, “Please bring the direction of the shadow into correspondence with the upper side of the portable terminal”. Also with this arrangement, it is possible for a user to easily understand the directions in the map image, just like with the arrangement according to the embodiments wherein the target object image is displayed.

### INDUSTRIAL APPLICABILITY

As explained above, the map providing apparatus, the portable terminal, the map providing method, and the map providing program according to the present invention are useful for application to an apparatus or the like that provides a map image to a portable terminal and are particularly suitable for an apparatus or the like that provides a map image in which it is possible to specify the directions on the map.

1-15. (canceled)

16. A map providing apparatus that receives, from a portable terminal including at least a display unit, location information indicative of a location of a portable terminal held by a user, and transmits a map image that corresponds to received location information to the portable terminal, the map providing apparatus comprising:
a reference direction specifying unit that, based on the received location information, specifies a reference direction that is a direction required when a user of the portable terminal brings the map image displayed on the display unit of the portable terminal into correspondence with actual directions and that is a direction of a target object that can be visually recognized by the user from the location;
a reference direction information generating unit that generates reference direction information for having the user understand specified reference direction; and
a transmitting unit that transmits generated reference direction information together with the map image to the portable terminal.

17. The map providing apparatus according to claim 16, wherein
the reference direction information generating unit generates the reference direction information as an image to be displayed, together with the map image, on the display unit.

18. The map providing apparatus according to claim 17, further comprising a map image editing unit that embeds the generated reference direction information into the map image to generate a reference direction information embedded map image, wherein
the transmitting unit transmits the reference direction information embedded map image to the portable terminal.

19. The map providing apparatus according to claim 16, further comprising a map direction specifying unit that specifies a map direction in the map image to be transmitted by the transmitting unit, wherein
the reference direction specifying unit specifies a reference direction with respect to the map direction specified by the map direction specifying unit.

20. The map providing apparatus according to claim 16, wherein
the target object is a shadow formed by sunlight, and
the reference direction specifying unit specifies a shadow direction to which the shadow extends, based on a date and time at which the transmitting unit transmits the reference direction information and the location information.

21. The map providing apparatus according to claim 20, further comprising:
a table storing unit that stores therein a shadow direction table of, in correspondence, sets of a date and a time at each of which the transmitting unit transmits the map image and shadow directions for the sets of a date and a time, wherein
the reference direction specifying unit specifies the shadow direction that is in correspondence with the date and time by referring to the shadow direction table.

22. The map providing apparatus according to claim 16, wherein
the target object is an astronomical object, and
the reference direction specifying unit specifies a direction of the astronomical object with respect to the location, based on the location information and a date and time at which the transmitting unit transmits the reference direction information.

23. The map providing apparatus according to claim 16, wherein
the target object is a landmark, and
the map providing apparatus further comprises a position information storing unit that stores therein position information that indicates a position of the landmark, and
the reference direction specifying unit specifies a direction of the landmark with respect to the location, based on the position information in the position information storing unit and the received location information.

24. The map providing apparatus according to claim 23, wherein
the position information storing unit stores therein a plurality of the landmarks and position information indicative of a location of each of the landmarks in corresponding manner,
the map providing apparatus further comprises a landmark selecting unit that selects, from the position information storing unit, a landmark corresponding to the reference direction information that is to be transmitted to the portable terminal, based on the received location information and the position information of the selected landmark, and
the reference direction specifying unit specifies the direction of the selected landmark.

25. The map providing apparatus according to claim 24, wherein
the landmark selecting unit selects the landmark based on the direction of the landmark with respect to the location.

26. The map providing apparatus according to claim 25, wherein
the transmitting unit transmits a map image that includes a route to a destination desired by the user, and
the landmark selecting unit selects the landmark, further based on a direction of the destination with respect to the location.

27. The map providing apparatus according to claim 24, wherein
the landmark selecting unit selects the landmark, based on a distance between the location and the landmark.

28. A portable terminal on which a map image is to be displayed, the portable terminal comprising:
a receiving unit that receives the map image;
a reference direction specifying unit that specifies a reference direction that is required when the received map image is brought into correspondence with actual directions, based on location information that indicates a location of the portable terminal;
a reference direction information generating unit that generates reference direction information for having a user of the portable terminal understand a specified reference direction; and
a display unit that displays generated reference direction information together with the map image.

29. The portable terminal according to claim 28, wherein
the display unit displays the map image and the reference direction information simultaneously.

30. The portable terminal according to claim 28, wherein
the receiving unit further receives map direction information that indicates a map direction that is a direction in the map image, and
the reference direction specifying unit specifies the reference direction with respect to the map direction, based on received map direction information.

31. A map providing method of receiving, from a portable terminal including at least a display unit, location information indicative of a location of a portable terminal held by a user, and transmitting a map image that corresponds to received location information to the portable terminal, the map providing method comprising:
specifying, based on the received location information, a reference direction that is a direction required when a user of the portable terminal brings the map image displayed on the display unit of the portable terminal into correspondence with actual directions and that is a direction of a target object that can be visually recognized by the user from the location;
generating reference direction information for having the user understand a specified reference direction; and
transmitting generated reference direction information together with the map image to the portable terminal.

32. A map displaying method of displaying a map image on a portable terminal, the map displaying method comprising:
receiving the map image;
specifying a reference direction that is required when the received map image is brought into correspondence with actual directions, based on location information that indicates a location of the portable terminal;
generating reference direction information for having a user of the portable terminal understand a specified reference direction; and
displaying generated reference direction information together with the map image.

33. A computer-readable recording medium that stores therein a computer program that causes a computer to implement a map providing method of receiving, from a portable terminal including at least a display unit, location information indicative of a location of a portable terminal held by a user, and transmitting a map image that corresponds to received location information to the portable terminal, the computer program causing the computer to execute:
specifying, based on the received location information, a reference direction that is a direction required when a user of the portable terminal brings the map image displayed on the display unit of the portable terminal into correspondence with actual directions and that is a direction of a target object that can be visually recognized by the user from the location;
generating reference direction information for having the user understand a specified reference direction; and
transmitting generated reference direction information together with the map image to the portable terminal.

34. A computer-readable recording medium that stores therein a computer program that causes a computer to implement a map displaying method of displaying a map image on a portable terminal, the computer program causing the computer to execute:
receiving the map image;
specifying a reference direction that is required when the received map image is brought into correspondence with actual directions, based on location information that indicates a location of the portable terminal;
generating reference direction information for having a user of the portable terminal understand a specified reference direction; and
displaying generated reference direction information together with the map image.
